(19) United States
(12) Patent Application Publication
(10) Pub. No.: US 2026/0245410 A1
(43) Pub. Date: Aug. 20, 2026

(54) DETECTION OF YAW INSTABILITIES IN VEHICLE COMBINATIONS

(71) Applicant: VOLVO TRUCK CORPORATION, Göteborg (SE)

(72) Inventors: Umur ERDINC, Göteborg (SE); Mats JONASSON, Partille (SE); Bengt JACOBSON, Mölnlycke (SE)

(73) Assignee: VOLVO TRUCK CORPORATION, Göteborg (SE)

(21) Appl. No.: 18/992,740

(22) PCT Filed: Jul. 15, 2022
(86) PCT No.: PCT/EP2022/069950

§ 371 Date: Jan. 9, 2025

(51) Int. Cl. G07C 5/04

(52) U.S. Cl. CPC G07C 5/04

(57) ABSTRACT

A method detects a yaw instability in a vehicle combination. The vehicle combination has a tractor unit and at least one trailing unit. The method includes determining a safe operating envelope for the vehicle combination based on a yaw rate of at least one unit and a current operating state of the vehicle combination, determining a current value of the yaw rate of the at least one unit, comparing the current value to the safe operating envelope, and if the current value is outside the safe operating envelope, determining that a yaw instability is present in the vehicle combination.

### FIELD

This disclosure relates to detection of unsafe operation in vehicle combinations. In particular, it relates to detection of yaw instabilities for combinations of at least two vehicle units.

### BACKGROUND

Multi-unit vehicle combinations are prone to different modes of unsafe operation including jack-knifing, trailer swing, rollover and off-tracking. Two of these, jack-knifing and trailer swing, can be grouped under the umbrella of yaw instabilities, as they are predominantly embodied in the yaw behaviour of the tractor and trailing units of a vehicle combination.

Jack-knifing occurs when the tractor unit of a vehicle combination starts to skid sideways in slippery road conditions and the driver is not able to correct the skidding in time with the proper amount of steering. The trailing unit pushes the tractor unit causing the tractor unit to turn around a vertical axis until it hits the trailing unit. Jack-knifing is one of the major sources of accidents in multi-unit vehicle combinations. Trailer swing occurs when the wheels of the trailing unit slip, for example due to slippery road conditions, while the wheels of the tractor unit do not. In this case, the trailing unit starts to swing around the vertical axis. All types of vehicle combinations are susceptible to such instabilities.

These instabilities can be exacerbated by the presence of propulsive elements, for example motors or braking systems, on the trailing unit. Such elements are used increasingly as electric vehicles become more popular. For example, electric motors may be present on some or all axles of the different units. In some instances, a controller of such a vehicle may activate the electric motors of only one axle or unit in order to propel the vehicle. For example, the controller may activate only the electric motors of a trailing unit if the battery of the tractor unit is emptier or if the tractor unit is a conventional tractor unit and the trailing unit is an electric trailer. Electric axles may also be used to capture energy via regenerative braking. A controller may cause only one axle or unit to perform regenerative braking without braking the other axles or units, for example if the battery of one unit is much emptier than the battery of another unit.

Propelling or braking with only one axle or unit may create the conditions for yaw instabilities more readily than conventional ways of propelling and braking. To avoid such situations, it is important to detect such yaw instabilities either in advance or at an early point of onset.

### SUMMARY

This disclosure attempts to solve the problems noted above by providing a method of detecting a yaw instability in a vehicle combination. Certain parameters of the vehicle combination are monitored with respect to certain limits to determine if the vehicle combination is operating in a safe manner. In particular, limits of the parameters can be used to determine a safe operating envelope for the vehicle combination. The limits are set based on a current operating states of the vehicle combination.

The method allows an upcoming or ongoing yaw instability in a vehicle combination to be detected with high accuracy and at an early stage. The yaw rate and articulation angle give good certainty on whether a jack-knife or trailer swing is taking place. By determining reference values for a safe operating envelope dynamically based on a current operating state of a vehicle combination, a more robust and responsive detection method is provided. In particular, changes in operating conditions that affect the likelihood of a yaw instability occurring, for example vehicle speed and road wheel angle, can be taken into account. This ensures that instabilities that might not be captured by a fixed safe operating envelope can be detected properly. In the opposite sense, false detections of instability captured by an inappropriately set safe operating envelope are avoided. By using combinations of a number of different parameters to determine the safe operating envelope, increased accuracy of detection can be provided.

According to an aspect, there is provided a method of detecting a yaw instability in a vehicle combination, the vehicle combination comprising a tractor unit and at least one trailing unit, the method comprising determining a safe operating envelope for the vehicle combination based on a yaw rate of at least one unit and a current operating state of the vehicle combination, determining a current value of the yaw rate of the at least one unit, comparing the current value to the safe operating envelope, and if the current value is outside the safe operating envelope, determining that a yaw instability is present in the vehicle combination.

Optionally, the current operating state of the vehicle combination comprises a longitudinal speed of the vehicle combination, a lateral acceleration of the tractor unit, a lateral acceleration of the trailing unit, a road wheel angle of the tractor unit and/or a road wheel angle of the trailing unit. Optionally, determining the safe operating envelope comprises determining a reference value for the yaw rate based on the current operating state of the vehicle combination. Optionally, the reference value for the yaw rate of the tractor unit, ω_{1,model}, is given by:

$${ω}_{1 , model} = \frac{{v}_{1 r} tan {δ}_{1}}{{L}_{1}}$$

where ν₁ᵣ is the longitudinal speed of the tractor unit, δ is the road wheel angle of the tractor unit, and L₁ is the wheelbase of the tractor unit.

Optionally, the reference value for the yaw rate of a first trailing unit, ω_{2,model}, is given by:

$${ω}_{2 , model} = \frac{{v}_{1 r}}{{L}_{2}} ( sin {θ}_{1 , 2} + cos {θ}_{1 , 2} \cdot \frac{{b}_{1} \cdot tan {δ}_{1}}{{L}_{1}} )$$

where L₂ is the wheelbase of the trailing unit, θ_{1,2} is the an articulation angle between the tractor unit and a first trailing unit, b is the distance from the rear axle of the tractor unit to a coupling point of the vehicle combination, and δ₁ is the road wheel angle of the tractor unit.

Optionally, the reference value for the yaw rate of trailing units i>2, ω_{i,model}, can be given by:

$${ω}_{i} = \frac{{v}_{ir} \cdot tan ( {θ}_{i - 1 , i} + {β}_{i - 1 , c} )}{{L}_{i}}$$

where β_{i-1,c} is the sideslip angle for unit i−1 at the coupling point.

Optionally, determining the safe operating envelope comprises determining a margin around the reference value for the yaw rate. Optionally, determining the margin comprises determining a fixed margin based on experimental data, or determining a variable margin based on the current operating state of the vehicle combination.

Optionally, the method further comprises determining the safe operating envelope for the vehicle combination based on an articulation angle and/or an articulation angular rate of consecutive units, determining a current value for the articulation angle and/or the articulation angular rate of the consecutive units, comparing the current value for the articulation angle and/or the articulation angular rate of the consecutive units to the safe operating envelope, and if a point defined by the current values is outside the safe operating envelope, determining that a yaw instability is present in the vehicle combination.

Optionally, determining the safe operating envelope of the articulation angle and/or the articulation angular rate of the consecutive units comprises determining a reference value for the articulation angle and/or the articulation angular rate of the consecutive units based on the current operating state of the vehicle combination. Optionally, the reference value for the articulation angle between a tractor unit and a first trailing unit, θ_{1,2,ss,model}, is given by:

$${θ}_{1 , 2 , ss , model} = \frac{{L}_{2}}{{L}_{1}} ( 1 - \frac{{b}_{1}}{{L}_{2}} ) tan {δ}_{1}$$

Optionally, the reference value for the articulation angular rate between a tractor unit and a first trailing unit, \dot{θ}_{1,2,model}, is given by:

$${\dot{θ}}_{1 , 2 , model} = - \frac{{v}_{1 r}}{{L}_{2}} sin {θ}_{1 , 2} + \frac{{v}_{1 r}}{{L}_{1}} ( 1 - \frac{{b}_{1}}{{L}_{2}} cos {θ}_{1 , 2} ) tan {δ}_{1}$$

Optionally, the reference value for the articulation angular rate between consecutive trailing units i, i+1, \dot{θ}_{i,i+1,model}, can be given by:

$${\dot{θ}}_{i , i + 1 , model} = {ω}_{\dot{ı}} - {ω}_{\dot{ı} + 1}$$

Optionally, determining the safe operating envelope comprises determining a margin around the reference value for the articulation angle and/or the articulation angular rate. Optionally, determining the margin comprises determining a fixed margin based on experimental data, or determining a variable margin based on the current operating state of the vehicle combination.

Optionally, the method further comprises determining the safe operating envelope for the vehicle combination based on a yaw angle and/or a yaw acceleration of at least one unit of the vehicle combination, determining a current value for the yaw angle and/or the yaw acceleration of the at least one unit, comparing the current value for the yaw angle and/or the yaw acceleration to the safe operating envelope, and if a point defined by the current values is outside the safe operating envelope, determining that a yaw instability is present in the vehicle combination.

Optionally, determining the safe operating envelope of the yaw angle and/or the yaw acceleration of the at least one unit comprises determining a reference value for the yaw angle and/or the yaw acceleration of the at least one unit based on the current operating state of the vehicle combination. Optionally, the reference value for the yaw angle of the at least one unit is a measured value or is given by the integral of the yaw rate of the unit. Optionally, the reference value for the yaw acceleration of the at least one unit is a measured value or is given by the derivative of the yaw rate of the unit. Optionally, determining the safe operating envelope comprises determining a margin around the reference value for the articulation angle and/or the articulation angular rate. Optionally, determining the margin comprises determining a fixed margin based on experimental data, or determining a variable margin based on the current operating state of the vehicle combination.

Optionally, the method comprises determining the safe operating envelope for the vehicle combination based on at least two parameters and a current operating state of the vehicle combination, determining a current value of each of the at least two parameters, comparing the current values to the safe operating envelope, and if a point defined by the current values is outside the safe operating envelope, determining that a yaw instability is present in the vehicle combination.

Optionally, the at least two parameters comprise a yaw rate of at least one unit of the vehicle combination, and at least one of the yaw rate of another unit of the vehicle combination, an articulation angle of consecutive units, an articulation angular rate of the consecutive units, the yaw angle of at least one unit of the vehicle combination, and the yaw acceleration of at least one unit of the vehicle combination.

Optionally, the method comprises determining that a jack-knife is present in the vehicle combination based on values from the tractor unit. Optionally, the method comprises determining that trailer swing is present in the vehicle combination based on values from at least one trailing unit. Optionally, the method comprises determining that a complete spin out is present in the vehicle combination based on values from the tractor unit and at least one trailing unit.

According to an aspect, there is provided a computer-readable medium having stored thereon instructions that, when executed by one or more processors cause execution of the method steps.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

Exemplary embodiments of the disclosure shall now be described with reference to the drawings in which:

FIG. 1 shows an example vehicle combination;

FIG. 2A shows jack-knifing of a vehicle combination;

FIG. 2B shows trailer swing in a vehicle combination;

FIG. 3 shows an example unit axis system for modelling a vehicle combination;

FIG. 4A shows a generic kinematic model of two units of a vehicle combination;

FIG. 4B shows a kinematic model of a vehicle combination comprising a tractor unit and a trailing unit;

FIG. 5A is a plot of the yaw rate of a tractor unit and a trailing unit for a jack-knife case;

FIG. 5B is a plot of the yaw rate of a tractor unit and a trailing unit for a trailer swing case;

FIG. 6A is a plot of the articulation angle of a vehicle combination for a jack-knife case;

FIG. 6B is a plot of the articulation angle of a vehicle combination for a trailer swing case;

FIG. 7 a flow chart illustrating a method of detecting a yaw instability in a vehicle combination;

FIG. 8 shows a safe operating envelope in a two-dimensional space; and

FIG. 9 is a block diagram illustrating an exemplary computer system in which embodiments of the present disclosure may be implemented.

### SPECIFIC DESCRIPTION

The invention will now be described more fully hereinafter with reference to the accompanying drawings, in which certain aspects of the invention are shown. The invention may, however, be embodied in many different forms and should not be construed as limited to the embodiments and aspects set forth herein; rather, the embodiments are provided by way of example so that this disclosure will be thorough and complete, and will fully convey the scope of the invention to those skilled in the art. Accordingly, it is to be understood that the present invention is not limited to the embodiments described herein and illustrated in the drawings; rather, the skilled person will recognize that many changes and modifications may be made within the scope of the appended claims. Like reference numerals refer to like elements throughout the description.

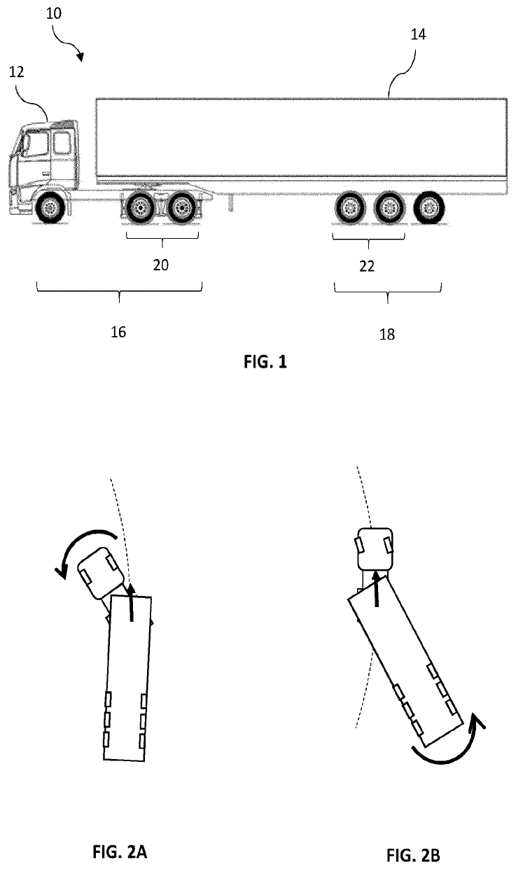

FIG. 1 shows an example vehicle combination 10 of the type considered in this disclosure. The vehicle combination 10 comprises a tractor unit 12 and at least one trailing unit 14. The tractor unit 12 is generally the foremost unit in a vehicle combination, and comprises the cabin for the driver, including steering controls, dashboard displays and the like. Generally, the tractor unit 12 is used to provide propulsion power for the vehicle combination 10. The at least one trailing unit 14 is generally used to store goods that are being transported by the vehicle combination. The at least one trailing unit 14 may be a truck, trailer, dolly and the like. The at least one trailing unit 14 may also provide propulsion to the vehicle combination 10. For example, the trailing unit 14 may comprise one or more electric motors configured to drive one or more axles or individual wheels of the trailing unit 14. A trailing unit 14 without a front axle is known as a semi-trailer.

A vehicle combination 10 may be defined by physical properties of the various units, for example a geometry of each unit and the combination as a whole, a number of axles on each unit, a distance between the axles on each unit, a number of motion support devices (including, for example, electric motors, mechanical service brakes and steering actuators) on each unit, a cornering stiffness on the tyres of each unit, an inertia about a yaw-axis of each unit, an electric motor peak torque output on each unit, an axle load on the axels of each unit.

In the example of FIG. 1, the tractor unit 12 comprises a number of tractor axles 16, and the trailing unit 14 comprises a number of trailer axles 18. At least one of the axles on each unit may be a driven axle, meaning that it is coupled to a propulsion system to drive the vehicle combination 10 forward. The propulsion systems may include traditional propulsion systems coupled to driven axles of the tractor unit 12, and/or electric motors coupled to driven axles of the tractor unit 12 or the trailing unit 14. For example, the three tractor axles 16 may comprise two driven tractor axles 20, and the three trailer axles 18 may comprise two driven trailer axles 22. A unit may be designated by the combination of axles present. In the example of FIG. 1, the vehicle combination 10 comprises a “6×4” tractor unit 12 and a “6×4” trailing unit 14, meaning each unit has six wheels, four of which are driven.

Whilst three tractor axles 16 and three trailer axles 18 are shown, it will be appreciated that any suitable number of axles may be provide on the tractor unit 12 and the at least one trailing unit 14. It will also be appreciated that any number of the tractor axles 16 and/or trailer axles 18 may be driven axles, including zero (i.e. one of the units may include at least one driven axle while the other does not). Furthermore, further trailing units 14 may be provided connected to each other. This gives rise to different types and designations of vehicle combinations.

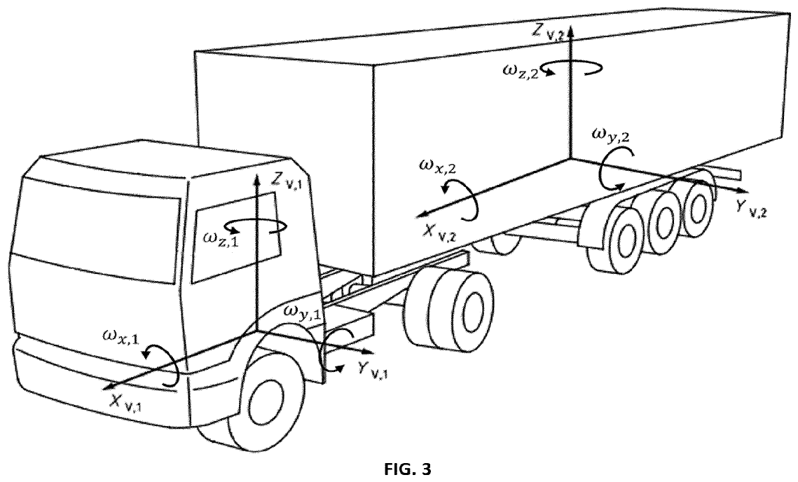

In order to detect yaw instabilities, proper definitions the unsafe behaviour modes are required. The unsafe behaviour modes that are considered as yaw instabilities are in FIGS. 2A and 2B. FIG. 2A shows jack-knifing the wheels of the tractor unit 12 slipping. In particular, the wheels on the two rear axles of the tractor unit 12 slip while the wheels on the trailing unit 14 do not slip, causing a jack-knife. FIG. 2B shows trailer swing due to the wheels of the trailing unit 14 slipping. In particular, the wheels on the trailing unit 14 slip while the wheels on the tractor unit 12 do not slip, causing trailer swing. An unsafe mode where both jack-knifing and trailer swing occur may be known as a complete spin out.

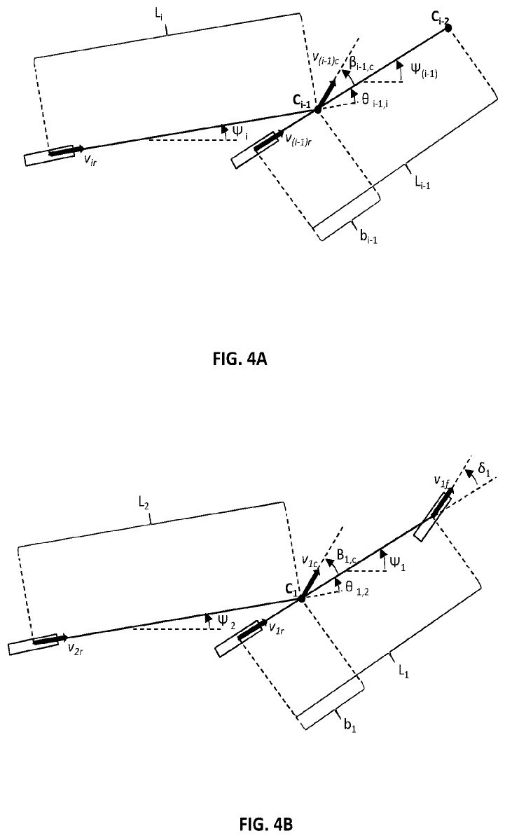

FIGS. 3 and 4 show examples of how the dynamics of a vehicle combination 10 can be modelled. In order to describe motion and dynamics of the different vehicle units a definition of coordinate systems and global forces acting on them is required. For this, the international standard for road vehicles ISO 8855 is used.

As shown in FIG. 3, X_{V,i}, Y_{V,i}, and Z_{V,i} are the unit axis systems where iϵ{1, 2, . . . n}, with the tractor unit 12 being unit number 1, and trailing units 14 getting increasingly higher numbers. Whilst only one trailing unit 14 is shown, it will be appreciated that further trailing units may be present in the vehicle combination 10. n is the total number of units of the vehicle combination 10. The rate of deviation around each axis is given by ω. The yaw rate of each unit is its rate of deviation about the Z axis, denoted ω_{z,i}. In the remainder of this disclosure, the yaw rate of a unit will be simply denoted ωᵢ.

Parameters and dimensions are defined per unit i on the vehicle combination 10, as shown in FIGS. 4A and 4B. FIG. 4A is a generic kinematic model of two units i−1 and i of a vehicle combination 10. Each unit has a wheelbase Lᵢ. The coupling point between units i−1 and i is denoted Cᵢ₋₁. A distance between a rear axle of a unit i−1 and the coupling point to the unit i is denoted bᵢ₋₁. Note that point Cᵢ₋₂ is the front axle of tractor in the case that i=2.

The angle between the longitudinal axes of consecutive units is known as the articulation angle θ. In particular, the articulation angle θ between units i and i+1 is given by θ_{i,i+1} (i.e. the articulation angle θ between the tractor unit 12 and the first trailing unit 14 is denoted θ_{1,2}). The rate of change of the articulation angle, known as the articulation angular rate, is denoted by \dot{θ}. The yaw angle of a unit is denoted ψᵢ. The sideslip angle of a unit is denoted βᵢ. β_{i-1,c} is the sideslip angle of unit i−1 at the coupling point. The longitudinal velocity of a unit is taken from a rear axle of the unit and is denoted Vir. The units have a road wheel angle δᵢ (shown in FIG. 4B) which is the angle between the direction of the wheels and the longitudinal direction of the unit.

In Error! Reference source not found.B, a kinematic model of a vehicle combination 10 comprising a tractor unit 12 and a trailing unit 14 is shown. The tractor unit has wheelbase L₁ and the trailing unit 14 has wheelbase L₂. The tractor unit 12 and the trailing unit 14 are connected via a moment free articulation point C₁. The distance from the rear axle of the tractor unit 12 to the coupling point C₁ is denoted as b₁. The tractor unit 12 has a front axle velocity denoted ν_{if}. The other parameters are given the appropriate subscripts as discussed above. The front axle of the tractor unit 14 is steered with a road wheel angle δ, which is determined by the steering controls of the tractor unit 14.

The vehicle is modelled as a single-track model, i.e., left and right wheels on a given axle are considered together. The real units can have axle groups with several axles, but in the model they are considered together, i.e., the tractor unit 14 is modelled with only one front and one rear wheel and the trailing unit 14 is modelled with only one wheel. The tyres are modelled with no tyre slip, which means that the tyre velocity vectors ν₁ᵣ, ν_{1f} and ν₂ᵣ are directed along the centreline of the tyres.

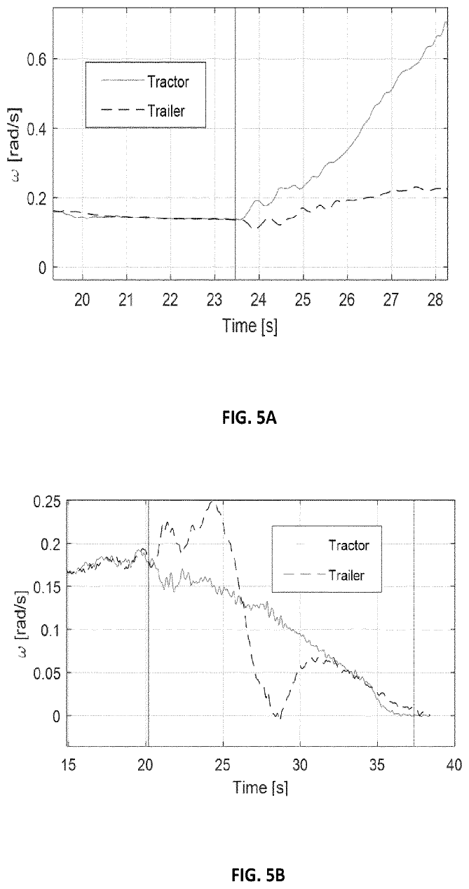

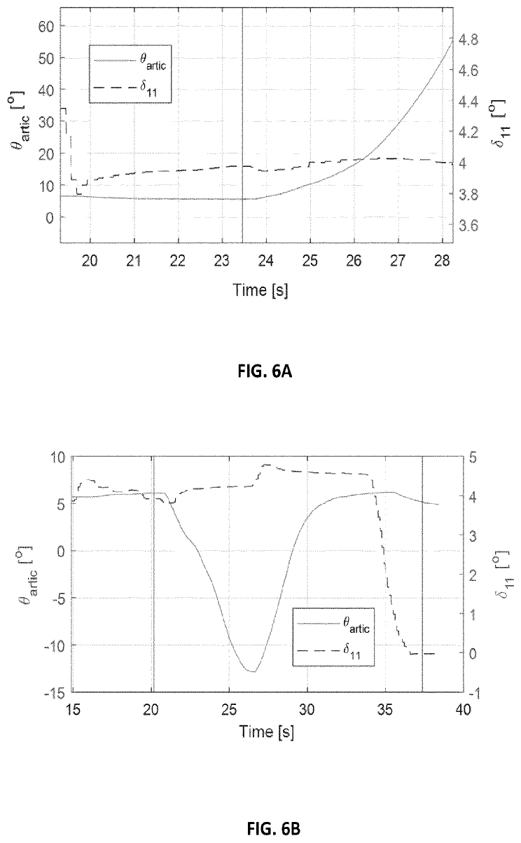

The inventors have determined that the yaw instabilities shown in FIGS. 2A and 2B can be described by the time response of certain parameters of the vehicle combination. Some of these time responses are shown in FIGS. 5 and 6. The time responses are based on real tests of a vehicle combination 10 comprising a tractor unit 12 and a trailing unit 14. The vehicle combination 10 is protected against a severe jack knife by means of a jack-knife protection cable connected between the tractor unit 12 and the trailing unit 14. The jack-knife protection cables allow maximum of 60° articulation angle, at which point the cable tightens and prevents a catastrophic jack-knife. The time responses in FIGS. 5 and 6 are shown up to the time when the jack knife-cable tightens. For trailer swing, on the other hand, the time responses are shown until the vehicle combination 10 reaches a standstill.

FIG. 5A is a plot of the yaw rate w of the tractor unit 12 and the trailing unit 14 for a jack-knife case. The vertical line at 23.5 s indicates the time instant at which braking started. As can be seen, both the yaw rate ω₁ of the tractor unit 12 and the yaw rate ω₂ of the trailing unit 14 grow from a steady state value once braking is applied. Therefore, both yaw rates can be indicative of a jack-knife occurring in the vehicle combination 10, and in particular the yaw rate ω₁ of the tractor unit 12. The yaw rate ω₁ of the tractor unit 12 grows much faster than the yaw rate ω₂ of the trailing unit 14. Therefore, the yaw rate ω₁ of the tractor unit 12 is a particularly good indicator of a jack-knife. Furthermore, the yaw acceleration \dot{ω}ᵢ increases for a short time before decreasing. The yaw angle ψᵢ will keep increasing as long as the vehicle combination 10 turns around a vertical axis.

FIG. 5B is a plot of the yaw rate ω of the tractor unit 12 and the trailing unit 14 for a trailer swing case. The vertical line at 20 s indicates the time instant at which braking started, and the vertical line at 37.5 s indicates the time instant at which braking stopped. As can be seen, the yaw rate ω₁ of the tractor unit 12 decreases, whilst the yaw rate ω₂ of the trailing unit 14 fluctuates, first increasing, then decreasing, increasing again and finally decreasing again. Therefore, both yaw rates can be indicative of trailer swing occurring in the vehicle combination 10, and in particular the yaw rate ω₂ of the trailing unit 14. The relatively large fluctuations in the yaw rate ωᵢ of the trailing unit 14 mean that the yaw rate ωᵢ of the trailing unit 14 is a particularly good indicator of trailer swing. Furthermore, the yaw acceleration \dot{ω}ᵢ increases for a short time before decreasing. In this case, it first grows to be positive before decreasing and becoming negative. The yaw angle ψᵢ will keep increasing as long as the vehicle combination 10 turns around a vertical axis. In this case, the trailing unit 14 stabilizes after some time and so the yaw angle ψ₂ of the trailing unit 14 will increase before decreasing and becoming close to the yaw angle ψ₁ of the tractor unit 12.

FIG. 6A is a plot of the articulation angle θ and the road wheel angle δ of a tractor unit for a jack-knife case. Again, the vertical line at 23.5 s indicates the time instant at which braking started. As can be seen, the articulation angle θ grows significantly in a positive direction. This is for a left-hand turn, and it will be appreciated that the articulation angle θ would grow in a negative direction for a right-hand turn. Therefore, the articulation angle θ can be indicative of a jack-knife occurring in the vehicle combination 10. The articulation angular rate \dot{θ} of the vehicle combination 10 increases for certain time in either a positive or negative direction until the tractor unit 12 hits the trailing unit 14 when the jack-knife occurs.

FIG. 6B is a plot of the articulation angle θ and the road wheel angle δ of a tractor unit for a trailer swing case. Again, the vertical line at 20 s indicates the time instant at which braking started, and the vertical line at 37.5 s indicates the time instant at which braking stopped. As can be seen, the articulation angle θ fluctuates, first decreasing, then increasing. Therefore, the articulation angle θ can be indicative of trailer swing occurring in the vehicle combination 10. The articulation angular rate \dot{θ} of the vehicle combination 10 increases for certain time in either a positive or negative direction. However, if the trailer swing is not catastrophic and stabilises over time, then the articulation angular rate will decrease and change sign to until the articulation angle reaches a quasi-steady state value.

With this in mind, a method is proposed in which certain parameters of the vehicle combination 10 are monitored with respect to certain limits to determine if the vehicle combination 10 is operating in a safe manner. In particular, limits of the parameters can be used to determine a safe operating envelope for the vehicle combination 10.

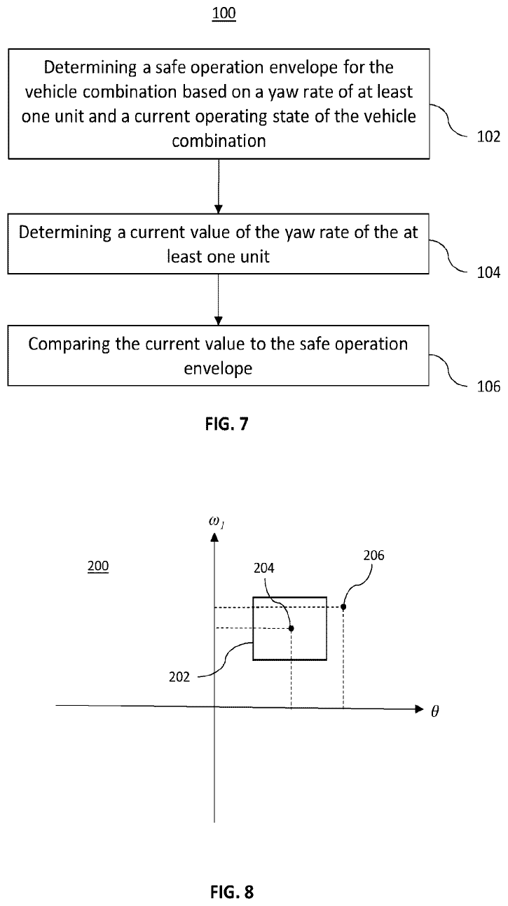

FIG. 7 is a flow chart illustrating a method 100 of detecting a yaw instability in a vehicle combination, such as the vehicle combination 10, comprising a tractor unit 12 and at least one trailing unit 14.

The method 100 comprises, at step 102, determining a safe operating envelope for the vehicle combination 10. The safe operating envelope defines a set of operating conditions where the vehicle is operating in a safe behaviour mode. More specifically, the safe operating envelope defines a set of operating conditions where a yaw instability such as a jack-knife or trailer swing is not present in the vehicle combination.

As will be discussed below, the safe operating envelope can be determined based on limits for one or more parameters of the vehicle combination 10. In particular, the safe operating envelope can be determined based on limits for a yaw rate ωᵢ of at least one unit. The limits may be determined taking into account the current operating state of the vehicle combination 10. Other parameters that may be used in determining the safe operating envelope are, for example, the articulation angle θ_{i,i+1} between consecutive units, the articulation angular rate \dot{θ}_{i,i+1} between consecutive units, the yaw angle ψᵢ of the tractor unit 12 or the at least one trailing unit 14, and the yaw acceleration \dot{ω}ᵢ of the of the tractor unit 12 or the at least one trailing unit 14. In some embodiments, safe operating envelope is determined based at least on a yaw rate ωᵢ of at least one unit.

The safe operating envelope can also be determined based on a current operating state of the vehicle combination 10. That is to say, limits of the parameters that define the safe operating envelope may be set dynamically as the vehicle combination is in motion. The current operating state of the vehicle combination 10 may be described by a longitudinal speed ν₁ᵣ of the vehicle combination 10, a lateral acceleration a_{y} of the tractor unit 12 and/or the at least one trailing unit 14, and/or a steering angle or road wheel angle δ of the tractor unit 12 and/or the at least one trailing unit 14. It is noted that the longitudinal speed ν₁ᵣ of the vehicle combination 10 is taken from a rear axle of the tractor unit 12, as it moves along the longitudinal axis of the vehicle combination 10, whereas the front axle is steered with the steering angle δ, and so is not precisely equal to the longitudinal speed of the vehicle combination 10.

The safe operating envelope may be described in a space, where each parameter determines a dimension of the safe operating envelope. An example of this is illustrated in FIG. 8. In this case, the space 200 is a two-dimensional space, with a first dimension described by the yaw rate of the tractor unit ω₁, and a second dimension described by the articulation angle θ_{1,2}. A safe operating envelope 202 is defined by upper and lower limits for each parameter. In this case, the space 200 is a two-dimensional space, and the limits are absolute and independent, meaning that the safe operating envelope 202 has the form of a box.

Whilst the space 200 and the safe operating envelope 202 are shown in two dimensions in FIG. 8, it will be appreciated that they could be described in one, three or more dimensions dependent on the number of parameters and units used. For example, one can use any combination of ωᵢ, θ_{i,i+1}, \dot{θ}_{i,i+1}, ψᵢ or \dot{ω}ᵢ in step 102 to give plots of different dimensions depending on the number of units. For combinations with many units, a subset can be selected such that, for example, one safe operating envelope is defined for units 1 and 2, and one for units 2 and 3. It will further be appreciated that the limits for a given parameter may not be absolute and independent. For example, limits of the parameters that define the safe operating envelope may be set dynamically based on a current operating state of the vehicle combination 10 as discussed above. This may result in the safe operating envelope 202 having a different form, such as a circle or an ellipse in two dimension, an ellipsoid in three dimensions, and the like. Determination of the size and form of the safe operating envelope will be described in more detail below.

Returning to FIG. 7, at step 104, current values of the relevant parameters of the vehicle combination 10 are determined. The yaw rate ωᵢ of a unit may be obtained directly from a gyroscope sensor of the unit. The articulation angle θ_{i,i+1} can be obtained either from an articulation angle sensor of the unit, or it can be estimated with any form of estimator known in the art, such as by using camera etc. The articulation angular rate θ_{i,i+1} can be determined by derivation of the articulation angle θ_{i,i+1}, by determining the difference of the yaw rates ωᵢ of consecutive units, or by a combination of the two with a filter such as Kalman filter. The yaw angle ψᵢ can be determined from a global positioning system (GPS) and/or a navigation system, perhaps using a filter where a first input is from a GPS/navigation system and a second input is from the integrals of yaw rates. The yaw acceleration \dot{ω}ᵢ can be determined by derivation of the yaw rate ωᵢ, for example with a filter such as Kalman filter to remove noise.

The current values determine a point in the space 200. Two such points 204, 206 are shown in FIG. 8. Each point is defined by a current value of the yaw rate of the tractor unit ω₁, and a current value of the articulation angle θ_{1,2}. As the space 200 in the example of FIG. 8 is two-dimensional, the points 204, 206 are defined by two values. However, it will be appreciated that the points 204, 206 could be defined by one, three or more dimensions dependent on the number of parameters used.

Returning to FIG. 7, at step 106 the current values of the relevant parameters of the vehicle combination 10 are compared to the safe operating envelope. If the current value is inside the safe operating envelope, then it is determined that the vehicle combination 10 is operating safely. However, if the current value is outside the safe operating envelope, then it is determined that a yaw instability is present in the vehicle combination 10. Therefore, to detect an upcoming or ongoing yaw instability, one can simply check if the relevant parameters are within the safe operating envelope at all times.

In the example of FIG. 8, the first point 204 has a yaw rate of the tractor unit ω₁, and an articulation angle θ_{1,2} within the respective limits for those parameters. Therefore, the first point 204 is within the safe operating envelope 202 and the vehicle combination 10 is considered to be operating safely. The second point 206, however, has an articulation angle θ_{1,2} outside the determined limits. Therefore, the second point 206 is outside the safe operating envelope 202 and it is determined that a yaw instability is present in the vehicle combination 10. It will be appreciated that, for a point described in any number of dimensions, it suffices that only one of the current parameter values is outside its respective limits to bring the point outside the safe operating envelope.

Dependent on which parameters are used to define the safe operating envelope, different modes of yaw instability can be determined. For example, if values from the tractor unit 12 are used, for example the yaw rate ω₁, yaw angle ψᵢ, and/or yaw acceleration \dot{ω}₁ of the tractor unit 12, it can be determined that a jack-knife is present in the vehicle combination. Similarly, if values from a trailing unit 14 are used, for example the yaw rate ωᵢ, yaw angle ψᵢ, and/or yaw acceleration \dot{ω}ᵢ of a trailing unit 14, it can be determined that trailer swing is present in the vehicle combination. Where values from both types of unit are used, a complete spin out can be detected.

The method 100 allows an upcoming or ongoing yaw instability in a vehicle combination to be detected with high accuracy and at an early stage. The yaw rate and articulation angle give good certainty on whether a jack-knife or trailer swing is taking place. By determining a safe operating envelope dynamically, based on a current operating state of the vehicle combination, a more robust and responsive detection method is provided. By using combinations of a number of different parameters to determine the safe operating envelope, increased accuracy of detection can be provided.

Returning to step 102 of the method 100, there are a number of ways in which the safe operating envelope can be determined. In one example, the safe operating envelope can be determined based on a reference value and a safety margin for each parameter. That is to say, a modelled or expected value of a given parameter can be determined, along with a buffer either side of that value, to define a safe operating range for the parameter. The reference value and/or the safety margin can be determined based on the current operating state of the vehicle combination 10. In another example, maximum and minimum values of a parameter can be determined, for example based on model and/or experimental data, as discussed above.

To determine a reference value for a given parameter based on the current operating state of the vehicle combination 10, certain relations may be used to define the parameter based on current conditions. Each of the yaw rate ωᵢ, yaw angle ψᵢ, and yaw acceleration \dot{ω}ᵢ of a unit, and the articulation angle θ_{i,i+1} and articulation angular rate \dot{θ}_{i,i+1} of consecutive units can be determined based on current conditions such as the longitudinal speed ν₁ᵣ of the vehicle combination 10, the steering angle or road wheel angle δ of the unit, and the wheelbase Lᵢ of the unit, the distance b from the rear axle of the tractor unit 12 to a coupling point C, and the other parameters.

A reference value for the yaw rate of the tractor unit, ω_{1,model}, can be given by:

$${ω}_{1 , model} = \frac{{v}_{1 r} tan {δ}_{1}}{{L}_{1}}$$

A reference value for the yaw rate of a first trailing unit, ω_{2,model}, can be given by:

$${ω}_{2 , model} = \frac{{v}_{1 r}}{{L}_{2}} ( sin {θ}_{1 , 2} + cos {θ}_{1 , 2} \cdot \frac{{b}_{1} \cdot tan {δ}_{1}}{{L}_{1}} )$$

A reference value for the yaw rate of a further trailing units i, ω_{i,model}, can be given by:

$${ω}_{i} = \frac{{v}_{ir} \cdot tan ( {θ}_{i - 1 , i} + {β}_{i - 1 , c} )}{{L}_{i}}$$

$$where$$

$${β}_{i , c} = arctan ( \frac{{b}_{i} \cdot tan ( {θ}_{i - 1 , i} + {β}_{i - 1 , c} )}{{L}_{i}} )$$

$$and$$

$${v}_{ir} = \frac{{v}_{( i - 1 ) r}}{cos ( {β}_{( i - 1 ) c} )} \cdot cos ( {θ}_{i - 1 , i} + {β}_{i - 1 , c} )$$

where θ_{i-1,i} is the articulation angle between units i−1 and i, β_{i,c} is the sideslip angle for unit i−, bᵢ is the distance from the rear axle of the unit i to a coupling point C, and Lᵢ is the wheelbase of unit i.

A reference value for the yaw angle ψᵢ a unit can be given by the integral of the yaw rate ωᵢ of the unit, or can be determined by other means, such as measurement. Similarly, a reference value for the yaw acceleration \dot{ω}ᵢ of a unit can be given by the derivative of the yaw rate ωᵢ of the unit, or can be determined by other means, such as measurement. In the case that these reference values are measured values, a filter such as a Kalman filter may be used.

For steady state driving, a reference value for the articulation angle between a tractor unit and a first trailing unit, θ_{1,2,ss,model}, can be given by:

$${θ}_{1 , 2 , ss , model} = \frac{{L}_{2}}{{L}_{1}} ( 1 - \frac{{b}_{1}}{{L}_{2}} ) tan {δ}_{1}$$

A reference value for the articulation angular rate between a tractor unit and a first trailing unit, \dot{θ}_{1,2,model}, can be given by:

$${\dot{θ}}_{1 , 2 , model} = - \frac{{v}_{1 r}}{{L}_{2}} sin {θ}_{1 , 2} + \frac{{v}_{1 r}}{{L}_{1}} ( 1 - \frac{{b}_{1}}{{L}_{2}} cos {θ}_{1 , 2} ) tan {δ}_{1}$$

A reference value for the articulation angle, θ_{1,2,model}, can also be given by the integral of the function for articulation angular rate, \dot{θ}_{1,2,model}.

A reference value for the articulation angular rate between consecutive trailing units i, i+1, \dot{θ}_{i,i+1},model, can be given by:

$${\dot{θ}}_{i , i + 1 , model} = {ω}_{\dot{ı}} - {ω}_{\dot{ı} + 1}$$

A reference value for the steady state articulation angle between consecutive trailing units i, i+1, θ_{i,i+1,ss,model}, can be found by using setting \dot{θ}_{i,i+1} to zero, then solving for θ_{i-1,i}.

Additionally, a small angle approximation can be applied for θ_{i,i+1}, where cos(θ_{i,i+1})≅1 and sin(θ_{i,i+1})≅θ_{i,i+1}.

Once reference values for the parameters are determined, a safety margin around the reference value is also determined in order to define a safe operating range for each parameter. The safety margin may be a fixed margin, determined for example based on model or experimental data. For example, a number of manoeuvres can be logged both with and without yaw instabilities. These can be performed with many different speeds, lateral accelerations, frictions, slopes, load distributions, road wheel angles, etc. These can then be evaluated and the margins can be tuned, if possible as a function of vehicle states and/or environmental variables. Alternatively, a machine learning model can be trained to tune the margins. Alternatively, the safety margin may be a variable margin, determined for example based on the current operating state of the vehicle combination 10.

To determine a fixed margin, experimental or model data relating to a vehicle combination 10 can be used to determine safe and unsafe operating conditions. This can be done using real tests, computer model simulations, a machine learning model, or other suitable means known in the art. For the yaw rate ωᵢ, of a unit, a margin can be set at for example ±5°/sec from the reference value, ±3°/sec from the reference value, ±1°/sec from the reference value, or any other suitable margin determined by the methods discussed above. For the articulation angle θ_{i,i+1}, a margin can be set at for example ±5° from the reference value, ±2° from the reference value, ±1° from the reference value, or any other suitable margin determined by the methods discussed above. For the articulation angular rate \dot{θ}_{i,i+1}, a margin can be set at for example ±5°/sec from the reference value, ±2°/sec from the reference value, ±1°/sec from the reference value, or any other suitable margin determined by the methods discussed above. For the yaw angle ψᵢ, a margin can be set at for example ±5° from the reference value, ±3° from the reference value, or any other suitable margin determined by the methods discussed above. For the yaw acceleration \dot{ω}ᵢ a margin can be set at for example ±3° from the reference value, ±1° from the reference value, or any other suitable margin determined by the methods discussed above.

To determine a variable margin based on the current operating state of the vehicle combination 10, experimental or model data relating to a vehicle combination 10 can be used to determine safe and unsafe operating conditions as the operating state of the vehicle combination 10 changes. This can be done using real tests, computer model simulations, a machine learning model, or other suitable means known in the art. The margin can vary with vehicle states such as longitudinal speed ν₁ᵣ of the vehicle combination 10, lateral acceleration a_{y} of the tractor unit 12 and/or the at least one trailing unit 14, and road wheel angle δ of the unit.

For example, as the longitudinal speed increases, the lateral acceleration increases, and the modelled reference value may become less reliable. Therefore, it may be desired to increase the margin as the longitudinal speed increases to take into account inaccuracies in the model. For example, for the articulation angle θ, the limit θ^{lim} may be given by:

$${θ}_{i , i + 1}^{lim} ( {v}_{ir} ) = 2 ° + max ( \frac{abs ( {v}_{ir} )}{10} , 1 ) \cdot 1 °$$

This means that for zero speed, the limit is 2°, and for speeds of 10 m/s (36 kph) and above, the limit is 3°, with a linear relationship between 0 m/s and 10 m/s.

As discussed above, as the lateral acceleration increases, the modelled reference value may become less reliable. Therefore, it may be desired to increase the margin as the lateral acceleration increases to take into account inaccuracies in the model. For example, for zero lateral acceleration, a fixed limit can be used as discussed. For a maximum realistic lateral acceleration of 0.4 g, where g is the gravitational acceleration, the limits may be increased, for example by 50%. It is noted that the maximum realistic lateral acceleration for heavy vehicles is typically between 0.3 g and 0.4 g. Between those two values, a linear interpolation can be used. For example, for the articulation angle θ, the limit θ^{lim} may be given by:

$${θ}_{i , i + 1}^{lim} ( {a}_{y , i} ) = 2 ° + max ( \frac{abs ( {a}_{y , i} )}{0.4 \cdot g} , 1 ) \cdot 1 °$$

As the road wheel angle increases, the lateral acceleration increases, and the modelled reference value may become less reliable. Therefore, it may be desired to increase the margin as the road wheel angle increases to take into account inaccuracies in the model. For example, for the articulation angle θ, the limit θ^{lim} may be given by:

$${θ}_{i , i + 1}^{lim} ( δ ) = 2 ° + max ( \frac{abs ( δ )}{10 °} , 1 ) \cdot 1 °$$

This means that for zero road wheel angle, the limit is 2°, and for road wheel angle having a magnitude of 10° and above, the limit is 3°, with a linear relationship between 0° and 10°.

By determining reference values and margins for a safe operating envelope dynamically based on a current operating state of a vehicle combination, a more robust and responsive detection method is provided. In particular, changes in operating conditions that affect the likelihood of a yaw instability occurring, for example vehicle speed and road wheel angle, can be taken into account. This ensures that instabilities that might not be captured by a fixed safe operating envelope can be detected properly. In the opposite sense, false detections of instability captured by an inappropriately set safe operating envelope are avoided.

A tyre model can be used in combination with the methods disclosed above. The tyre model can be that disclosed in the Vehicle Dynamics Compendium from Bengt Jacobson et al, Vehicle Dynamics Group, Division Vehicle and Autonomous Systems, Department of Mechanics and Maritime, Chalmers University of Technology, www.chalmers.se. For example, the tyre model may take into account the cornering stiffness of the tyres of the vehicle combination, which is a value defining tires how much lateral force is created for a certain side slip angle of the tyre. This also allows forces and sideslip to be taken into account, giving a more robust model.

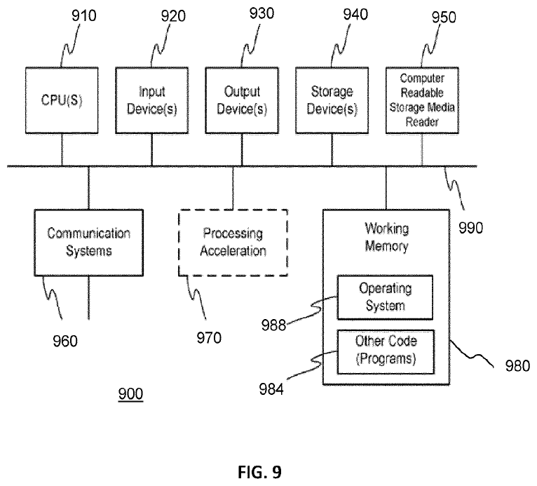

FIG. 9 is a block diagram illustrating an exemplary computer system 900 in which embodiments of the present disclosure may be implemented. This example illustrates a computer system 900 such as may be used, in whole, in part, or with various modifications, to provide the functions of the disclosed system. For example, various functions may be controlled by the computer system 900, including, merely by way of example, simulating, determining, classifying, receiving, etc.

The computer system 900 is shown comprising hardware elements that may be electrically coupled via a bus 990. The hardware elements may include one or more central processing units 910, one or more input devices 920 (e.g., a mouse, a keyboard, etc.), and one or more output devices 930 (e.g., a display device, a printer, etc.). The computer system 900 may also include one or more storage devices 940. By way of example, the storage devices 940 may be disk drives, optical storage devices, solid-state storage device such as a random-access memory (“RAM”) and/or a read-only memory (“ROM”), which can be programmable, flash-updateable and/or the like.

The computer system 900 may additionally include a computer-readable storage media reader 950, a communications system 960 (e.g., a modem, a network card (wireless or wired), an infra-red communication device, Bluetooth™ device, cellular communication device, etc.), and a working memory 980, which may include RAM and ROM devices as described above. In some embodiments, the computer system 900 may also include a processing acceleration unit 970, which can include a digital signal processor, a special-purpose processor and/or the like.

The computer-readable storage media reader 950 can further be connected to a computer-readable storage medium, together (and, optionally, in combination with the storage devices 940) comprehensively representing remote, local, fixed, and/or removable storage devices plus storage media for temporarily and/or more permanently containing computer-readable information. The communications system 960 may permit data to be exchanged with a network, system, computer and/or other component described above.

The computer system 900 may also comprise software elements, shown as being currently located within the working memory 980, including an operating system 988 and/or other code 984. It should be appreciated that alternative embodiments of a computer system 900 may have numerous variations from that described above. For example, customised hardware might also be used and/or particular elements might be implemented in hardware, software (including portable software, such as applets), or both. Furthermore, connection to other computing devices such as network input/output and data acquisition devices may also occur.

Software of the computer system 900 may include code 984 for implementing any or all of the function of the various elements of the architecture as described herein. For example, software, stored on and/or executed by a computer system such as the system 900, can provide the functions of the disclosed system. Methods implementable by software on some of these components have been discussed above in more detail.

1. A method of detecting a yaw instability in a vehicle combination, the vehicle combination comprising a tractor unit and at least one trailing unit, the method comprising:
determining a safe operating envelope for the vehicle combination based on a yaw rate of at least one unit and a current operating state of the vehicle combination;
determining a current value of the yaw rate of the at least one unit;
comparing the current value to the safe operating envelope; and
if the current value is outside the safe operating envelope, determining that a yaw instability is present in the vehicle combination;
wherein determining the safe operating envelope comprises determining a reference value for the yaw rate based on the current operating state of the vehicle combination, wherein the reference value for the yaw rate of the tractor unit, ω_{1,model}, is given by:
$${ω}_{1 , model} = \frac{{v}_{1 r} tan {δ}_{1}}{{L}_{1}}$$
where ν₁ᵣ is the longitudinal speed of the tractor unit, δ₁ is the road wheel angle of the tractor unit, and L₁ is the wheelbase of the tractor unit.

2. The method of claim 1, wherein the current operating state of the vehicle combination comprises a longitudinal speed of the vehicle combination, a lateral acceleration of the tractor unit, a lateral acceleration of the trailing unit, a road wheel angle of the tractor unit and/or a road wheel angle of the trailing unit.

3. (canceled)

4. (canceled)

5. The method of claim 1, wherein the reference value for the yaw rate of a first trailing unit, ω_{2,model}, is given by:
$${ω}_{2 , model} = \frac{{v}_{1 r}}{{L}_{2}} ( sin {θ}_{1 , 2} + cos {θ}_{1 , 2} \cdot \frac{{b}_{1} \cdot tan {δ}_{1}}{{L}_{1}} )$$
Where ν₁ᵣ is the longitudinal speed of the tractor unit, L₂ is the wheelbase of the trailing unit, θ_{1,2} is the articulation angle between the tractor unit and a first trailing unit, b₁ is the distance from the rear axle of the tractor unit to a coupling point of the vehicle combination, δ₁ is the road wheel angle of the tractor unit, and L₁ is the wheelbase of the tractor unit.

6. The method of claim 1, wherein the reference value for the yaw rate of trailing units i>2, ω_{i,model}, can be given by:
$${ω}_{i} = \frac{{v}_{ir} \cdot tan ( {θ}_{i - 1 , i} + {β}_{i - 1 , c} )}{{L}_{i}}$$
Where νᵢᵣ is the longitudinal speed of the unit i, θ_{i-1,i} is the articulation angle between units i−1 and i, β_{(i-1)c} is the sideslip angle for unit i−1 at the coupling point, and Lᵢ is the wheelbase of the unit i.

7. The method of claim 1, wherein determining the safe operating envelope comprises determining a margin around the reference value for the yaw rate.

8. The method of claim 7, wherein determining the margin comprises determining a fixed margin based on experimental data, or determining a variable margin based on the current operating state of the vehicle combination.

9. The method of claim 1, further comprising:
determining the safe operating envelope for the vehicle combination based on an articulation angle and/or an articulation angular rate of consecutive units;
determining a current value for the articulation angle and/or the articulation angular rate of the consecutive units;
comparing the current value for the articulation angle and/or the articulation angular rate of the consecutive units to the safe operating envelope; and
if a point defined by the current values is outside the safe operating envelope, determining that a yaw instability is present in the vehicle combination.

10. The method of claim 9, wherein determining the safe operating envelope of the articulation angle and/or the articulation angular rate of the consecutive units comprises determining a reference value for the articulation angle and/or the articulation angular rate of the consecutive units based on the current operating state of the vehicle combination.

11. The method of claim 9, wherein the reference value for the articulation angle between a tractor unit and a first trailing unit, θ_{1,2,ss,model}, is given by:
$${θ}_{1 , 2 , ss , model} = \frac{{L}_{2}}{{L}_{1}} ( 1 - \frac{{b}_{1}}{{L}_{2}} ) tan {δ}_{1}$$
where L₂ is the wheelbase of the trailing unit, L₁ is the wheelbase of the tractor unit, b₁ is the distance from the rear axle of the tractor unit to a coupling point of the vehicle combination, and δ₁ is the road wheel angle of the tractor unit.

12. The method of claim 9, wherein the reference value for the articulation angular rate between a tractor unit and a first trailing unit, \dot{θ}_{1,2,model}, is given by:
$${\dot{θ}}_{1 , 2 , model} = - \frac{{v}_{1 r}}{{L}_{2}} sin {θ}_{1 , 2} + \frac{{v}_{1 r}}{{L}_{1}} ( 1 - \frac{{b}_{1}}{{L}_{2}} cos {θ}_{1 , 2} ) tan {δ}_{1}$$
where ν₁ᵣ is the longitudinal speed of the tractor unit, L₂ is the wheelbase of the trailing unit, θ_{1,2} is the articulation angle between the tractor unit and a first trailing unit, L₁ is the wheelbase of the tractor unit, b₁ is the distance from the rear axle of the tractor unit to a coupling point of the vehicle combination, and δ₁ is the road wheel angle of the tractor unit.

13. The method of claim 9, wherein the reference value for the articulation angular rate between consecutive trailing units i, i+1, \dot{θ}_{i,i+1,model}, can be given by:
$${\dot{θ}}_{i , i + 1 , model} = {ω}_{i} - {ω}_{i + 1}$$
where ωᵢ is the yaw rate of unit i.

14. The method of claim 8, wherein determining the safe operating envelope comprises determining a margin around the reference value for the articulation angle and/or the articulation angular rate.

15. The method of claim 14, wherein determining the margin comprises determining a fixed margin based on experimental data, or determining a variable margin based on the current operating state of the vehicle combination.

16. The method of claim 1, further comprising:
determining the safe operating envelope for the vehicle combination based on a yaw angle and/or a yaw acceleration of at least one unit of the vehicle combination;
determining a current value for the yaw angle and/or the yaw acceleration of the at least one unit;
comparing the current value for the yaw angle and/or the yaw acceleration to the safe operating envelope; and
if a point defined by the current values is outside the safe operating envelope, determining that a yaw instability is present in the vehicle combination.

17. The method of claim 16, wherein determining the safe operating envelope of the yaw angle and/or the yaw acceleration of the at least one unit comprises determining a reference value for the yaw angle and/or the yaw acceleration of the at least one unit based on the current operating state of the vehicle combination.

18. The method of claim 17, wherein the reference value for the yaw angle of the at least one unit is a measured value or is given by the integral of the yaw rate of the unit.

19. The method of claim 17, wherein the reference value for the yaw acceleration of the at least one unit is a measured value or is given by the derivative of the yaw rate of the unit.

20. The method of claim 17, wherein determining the safe operating envelope comprises determining a margin around the reference value for the articulation angle and/or the articulation angular rate.

21. The method of claim 20, wherein determining the margin comprises determining a fixed margin based on experimental data, or determining a variable margin based on the current operating state of the vehicle combination.

22. The method of claim 1, comprising:
determining the safe operating envelope for the vehicle combination based on at least two parameters and a current operating state of the vehicle combination;
determining a current value of each of the at least two parameters;
comparing the current values to the safe operating envelope; and
if a point defined by the current values is outside the safe operating envelope, determining that a yaw instability is present in the vehicle combination.

23. The method of claim 22, wherein the at least two parameters comprise a yaw rate of at least one unit of the vehicle combination, and at least one of the yaw rate of another unit of the vehicle combination, an articulation angle of consecutive units, an articulation angular rate of the consecutive units, the yaw angle of at least one unit of the vehicle combination, and the yaw acceleration of at least one unit of the vehicle combination.

24. The method of claim 1, comprising determining that a jack-knife is present in the vehicle combination based on values from the tractor unit.

25. The method of claim 1, comprising determining that trailer swing is present in the vehicle combination based on values from at least one trailing unit.

26. A non-transitory computer-readable medium having stored thereon instructions that, when executed by one or more processors cause execution of the method steps according to claim 1.
